(19) United States
(12) Patent Application Publication
(10) Pub. No.: US 2012/0060202 A1
(43) Pub. Date: Mar. 8, 2012

(54) CONTENT SERVICE SYSTEM, CONTENT SERVER, CONTENT TERMINAL AND CONTENT SERVICE METHOD

(75) Inventors: David Pu, Beijing (CN); Jerry Wang, Beijing (CN)

(73) Assignee: BEIJING RUIXIN ONLINE SYSTEM TECHNOLOGY CO., LTD, Beijing (CN)

(21) Appl. No.: 13/039,655

(22) Filed: Mar. 3, 2011

(30) Foreign Application Priority Data
Sep. 8, 2010 (CN) 201010275695.6

(51) Int. Cl. G06F 15/16; H04L 9/32

(52) U.S. Cl. 726/3; 709/218

(57) ABSTRACT

The present invention discloses a content service system, which comprises a content server and a content terminal that are connected via the internet, the content server is further connected with a client via the internet and comprises: a content database, for storing content data to be downloaded by the content terminal via the internet; and a message queue module, for receiving command messages from the client via the internet which specifies the content data to be downloaded by the content terminal; the content terminal comprises: a message acquiring module, for communicating with the content server to acquire the command message; a content downloading module, for downloading the specified content data from the content server via the internet according to the command messages and storing the specified content data locally; and a content playing module, for playing the content data which is stored locally. The present invention also relates to a corresponding content service method, a content server, and a content terminal. With the solutions of the present invention, the client can select freely the content data on the content server and control the content terminal in the home for downloading, storing locally, and playing.

### FIELD OF THE INVENTION

The present invention relates to the art of internet content service, and particularly to an internet-based content service system, content server, content terminal, and content service method.

### BACKGROUND OF THE INVENTION

In the prior art, the user who is watching TV usually passively receives regular programs that the service provider provides via the satellite broadcast network, but cannot actively select the TV programs. As for devices by which the user can actively select the content to play, such as a household DVD player, there is no plenty of content resources for the user to select.

On the other hand, there exists in the prior arta household network streaming media player which can be used with the TV set. With this kind of player, the user can not only actively select the contents to play, but also find a lot of available resources from the network. Therefore, it is becoming the object of pursuit for enthusiasts of household digital products. However, this streaming media player in the prior art usually can only spare certain buffer zones (e.g. 20 M of the memory, due to the limited resources of the embedded device) to cache partial video data, while being unable to support for playing after downloading. Therefore, this player is limited to a large extent by the bandwidth and the network status. Besides, the intellectual property ownership for the contents being played is not clear, which may bring infringement risks to the user. In addition, this network streaming media player poses a demanding requirement on the performance of the computer terminal and the user's ability to operate the terminal, and thus is not suitable for all consumer groups or for users of all age groups.

### SUMMARY OF THE INVENTION

The embodiments of the present invention aim to provide a content service system, a content server, a content terminal, and a content service method to solve the problems described above existing in the similar device and method in the prior art.

To realize these objects, an embodiment of the present invention provides a content service system, which comprises a content server and a content terminal that are connected via the internet, wherein

the content server is further connected with a client via the internet and comprises:
a content database, for storing content data to be downloaded by the content terminal via the internet; and
a message queue module, for receiving command messages from the client via the internet, the command messages being used to specify the content data to be downloaded by the content terminal;

the content terminal comprises:
a message acquiring module, for accessing the content server via the internet to acquire the command messages; and
a content downloading module, for downloading the specified content data from the content server via the internet according to the command messages, and storing the specified content data locally for playing.

An embodiment of the present invention further provides a content server, which is connected with a client and a content terminal respectively via the internet, comprising:
a content database, for storing content data to be downloaded by the content terminal via the internet; and
a message queue module, for receiving command messages from the client via the internet and storing the command messages according to the terminal ID of the content terminal, the command messages being used to specify the content data to be downloaded by the content terminal.

An embodiment of the present invention further provides a content terminal, which is connected with a content server via the internet, comprising:
a message acquiring module, for accessing the content server via the internet according to a terminal ID of the content terminal to acquire command messages of a client, the command messages being used to specify the content data to be downloaded by the content terminal; and
a content downloading module, for downloading the content data from the content server via the internet according to the command messages, and storing the content data locally for playing.

An embodiment of the present invention further provides a content service method, which is applied to a content service system including a content server and a content terminal that are connected via the internet, the content server is further connected with a client via the internet, the method comprising the steps of:
storing content data to be downloaded by the content terminal via the internet in the content server, and after receiving command messages from a client via the internet, storing the command messages according to a terminal ID of the content terminal in the content server, the command messages being used to specify the content data to be downloaded by the content terminal;
accessing the content server via the internet by the content terminal to acquire the command message according to a terminal ID of the content terminal, downloading the specified content data from the content server via the internet according to the command messages, and storing the specified content data locally in the content terminal for playing.

As can be seen from the above solutions, according to the embodiments of the present invention, by connecting the internet between the client and the content server and between the content server and the content terminal, it is possible for the client to select freely content data in the content server and specify the content terminal in the home to download the content data and store the content data locally. As a result, the content data which has been stored locally can be played directly with the content terminal when the user returns home. In this way, the phenomena, in which the streaming media cannot be played smoothly due to the network problems, can be avoided, and it is more convenient for the user to operate.

### BRIEF DESCRIPTION OF THE DRAWINGS

FIG. 1 is a structural diagram showing an embodiment of a content service system according to the present invention;

FIG. 2 is a structural diagram showing an embodiment of a content server according to the present invention;

FIG. 3 is a structural diagram showing an embodiment of a content terminal according to the present invention;

FIG. 4 is a flow chart showing an embodiment of a content service method according to the present invention.

### DETAILED DESCRIPTION OF THE EMBODIMENTS

Hereinafter, specific embodiments of the present invention will be described in details. It should be understood that the embodiments described herein are presented only by way of example, and do not intend to limit the present invention.

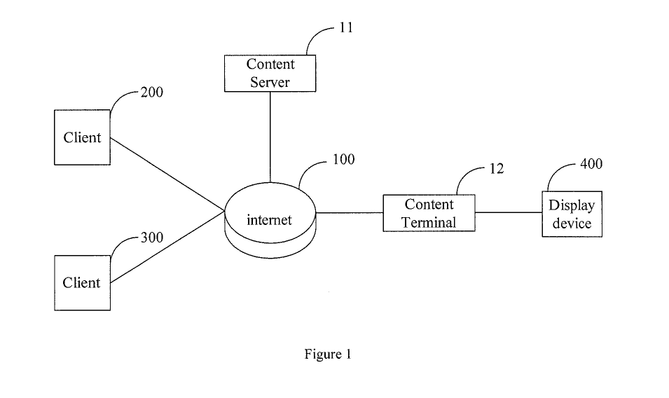

FIG. 1 is a structural diagram showing an embodiment of a content service system according to the present invention. As shown in the figure, the content service system of this embodiment comprises a content server 11 and a content terminal 12 which are connected with each other by an internet 100, and the content server 11 is further connected with clients 200, 300 via the internet 100. In a preferred embodiment, the content server 11 is provided and maintained by a service provider, and is comprised of computers and mass storage devices. A lot of high definition and high quality TV programs and film sources are stored in the content server 11. The content server 11 is also responsible for providing the content terminal 12 with the maintenance of the command message queues, and providing the clients 200, 300 with management interfaces for the content terminal 12. In a preferred embodiment, the content terminal 12 is arranged in the home. On one hand, the content terminal 12 is connected with the content server 11 via the internet 100, for the purpose of accessing the content server 11 to acquire command messages sent by the clients 200, 300 etc. On the other hand, the content terminal 12 is connected with a display device 400 like a TV set via a video outputting interface, and plays the content data specified by the client after it is downloaded from the content server 11 according to the command messages. The client can not only be a mobile terminal like a mobile phone, but also be for example a computer terminal in the office. Obviously, the present invention can be implemented in a manner that a content terminal corresponds to clients of one or more user, as shown in the above embodiment, or that a client corresponds to one or more slave content terminals.

As a message relay means between the clients 200, 300 and the content terminal 12, the content server 11 can identify command messages from various platforms like a smart/non-smart phone and a computer, and store the command messages in queue according to the terminal ID of the content terminal 12, so that the content terminal 12 can access the content server 11 at regular intervals to acquire the command messages. Thus, in a preferred embodiment, the content server 11 processes the command messages sent by various platforms and normalizes the command messages into a standard format that the content terminal 12 can identify. In this way, as an embedded device, the content terminal 12 can be free from processing a rather complicated communication protocol, and thus it is not required to be provided with a complex communication module. On the contrary, it is only necessary for the content terminal 12 to focus on interacting with the content server 11 and supporting the playing of the content data. This reduces the cost and size of the device.

In a preferred embodiment, the client 200 is a mobile phone and the client 300 is a computer, both of which can access the content server 11 in a manner of visiting a website. The content server 11 presents the stored content data to the clients 200, 300 in a form of web pages, so that it is convenient for the user to select the specified content data. The content server 11 can also provide an interface on the page for authentication login, and the user can be authenticated by inputting a preset username/password into the interface. An authenticated user can control the content terminal 11 by means of a terminal management interface provided by the content server 11, wherein the control may comprise operations of adding a new content terminal, checking the online status of the content terminal, controlling an on-line content terminal to download specified content data, etc.

In another embodiment, a client software provided by the provider of the content server 11 can be installed in the clients 200, 300. The client software has instructions stored thereon which when executed by a processor of the client 200 or the client 300 cause the processor to update data synchronously with the content server 11 over the internet, so as to provide an interface for presenting the content data and an interface for authentication login. In this way, by running the client software on the clients 200, 300, the user can directly access the content server 11, and perform operations like looking over the content data and controlling the content terminal 12.

In a further embodiment, the content server 11 can provide an interface through which the authentication is conducted with the terminal ID. By doing so, the client like a non-smart phone, which can neither install the client software nor access the internet, can be authenticated on the content server 11 by sending a short message containing the terminal ID of the related content terminal. In the same way, by interacting with the content server 11 using short messages, the client can check the online status of the content terminal 12 via the content server 11, select the specified content data and control a content terminal to download the specified content data.

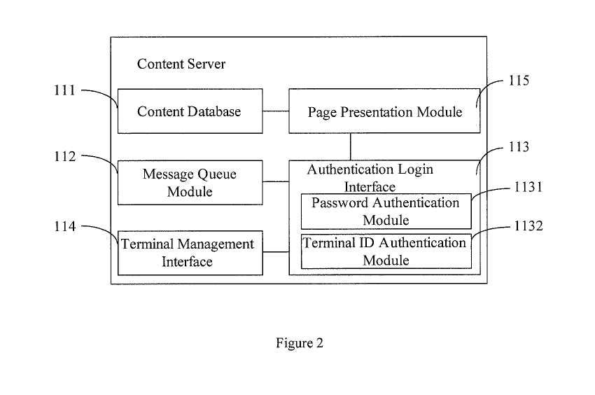

Furthermore, a content server according to an embodiment of the present invention can be applied to the content server 11 in the above embodiment. As shown in FIG. 2, in this embodiment, the content server comprises a content database 111 and a message queue module 112. In this context,
the content database 111 stores content data to be downloaded by the content terminal 12 via the internet 100; in a preferred embodiment, these content data may be a mass of high definition TV programs, film sources, etc.;
the message queue module 112 receives command messages from the clients 200, 300 via the internet 100, the command messages being used to specify the content data to be downloaded by the content terminal 12; in a preferred embodiment, the message queue module 112 further stores the command messages in queue according to the terminal ID of the content terminal 12; in another embodiment, the message queue module 112 is also responsible for normalizing the command messages generated by the client in various platforms (e.g. a smart/non-smart phone, a computer, etc.) into a standard format that the content terminal 12 can identify, so that the content terminal 12 can acquire the command messages directly.

In a preferred embodiment, the content server 11 further comprises a terminal management interface 114, through which the clients 200, 300 can add a content terminal, check the online status of a content terminal, and send command messages.

In a preferred embodiment, the content server 11 further comprises an authentication login interface 113, through which the clients 200, 300 can be authenticated, so that the clients 200, 300 which have been authenticated can operate the content terminal 12 through the terminal management interface 114. In a preferred embodiment, the authentication login interface 113 can comprise a password authentication module 1131 and/or a terminal ID authentication module 1141. The password authentication module 1131 performs authentication for the clients 200, 300 by verifying the username and password inputted by the user, and the terminal ID authentication module 1141 performs authentication for the clients 200, 300 by verifying the terminal ID of a content terminal. The terminal ID of the content terminal in this context may be contained in a carrier like a short message.

In a preferred embodiment, the content server 11 further comprises a page presentation module 115. The page presentation module 115 presents the content data stored in the content database 111 in pages to the clients 200, 300, and provides an interface for the clients 200, 300 to input a username and a password and an interface for indicating whether the content terminal 12 is online.

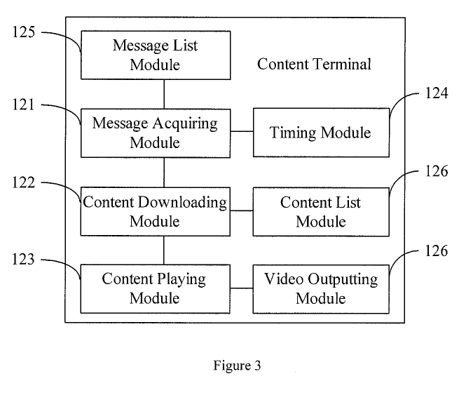

The content terminal according to an embodiment of the present invention can be applied to the content terminal 12 in the above embodiment. As shown in FIG. 3, in this embodiment, the content terminal comprises a message acquiring module 121 and a content downloading module 122. In this context,
the message acquiring module 121 accesses the content server 11 via the internet 100 according to the terminal ID of the content terminal 12 to acquire command messages from a client, the command messages being used to specify the content data to be downloaded by the content terminal 12;
the content downloading module 122 downloads the specified content data from the content server 11 via the internet 100 according to the command messages, and stores the specified content data locally for playing. In a preferred embodiment, prior to the downloading, it is necessary for the content downloading module 122 to analyze the command messages acquired from the content server 11. As described above regarding the system of the present invention, since the receipt and normalization of messages from various platforms have been processed by the content server 11, it is only necessary for the content downloading module 122 to analyze the acquired command messages according to a preset format. In a preferred embodiment, the content downloading module 122 can also comprise suitable mass storage media and buffer media. The mass storage media can not only store the content data downloaded from the content server 11, but can also store the content data from other sources (e.g., the content data copied directly via a USB interface by the user, which is not described in details herein for clarity).

In a preferred embodiment, the content terminal 12 further comprises a content playing module 123. The content playing module 123 is used to play the content data which is downloaded and locally stored by the content downloading module 122, and can support decoding and playing of currently popular video formats (including HD video with a resolution of 1080p or higher).

In a preferred embodiment, the content terminal 12 further comprises a timing module 124, for controlling the message acquiring module 121 to access the content server 11 at regular intervals to acquire command messages. In a preferred embodiment, the content server 11 can determine the online status of the content terminal 12 according to the access time interval of the message acquiring module 121. In a preferred embodiment, the time interval of the timing module 124 can be set sufficiently small, so as to ensure the correct feedback of the online status and a timely receipt of command messages from the clients 200, 300.

In a preferred embodiment, the content terminal 12 further comprises a message list module 125, for presenting the command messages acquired by the message acquiring module 121 in lists to the user, so that the user can check the downloading progress, select to play online the content data which has not been downloaded, and select to play locally the content data which has been downloaded. In a preferred embodiment, after the message acquiring module 121 acquires command messages from the content server 11, the message list module 125, which is connected with the message acquiring module 121, notifies the user for example by showing a flashing mailbox icon on a display interface. The display interface in this context can be a small LCD screen incorporated in the content terminal 12, and can also be the display device 400 connected with the content terminal 12. Then, upon seeing the notification indicating that the content terminal 12 receives new command messages or at any other time, the user can select to check respective command messages by using the message list provided by the message list module 125. As a result, the user can check the downloading progress of the content data relating to respective command messages (e.g., “50% has been downloaded”), select to play online the content data which has not been downloaded, select to play locally the content data which has been downloaded, and the like.

In a preferred embodiment, the content terminal 12 further comprises a content list module 126, for presenting the content data which has been stored locally in lists to the user so that the user can play selectively the content data. This can show to some extent the advantage of the content terminal of the present embodiment over the network streaming media player and the STB (Set Top Box). Both the network streaming media player and the STB are either unable to maintain always a smooth video playing due to being limited by the film sources or the network, or only allow watch of the preset movies or TV programs due to being limited by the service provider. On the contrary, the content terminal 12 of the present embodiment can firstly download the specified content data under the control of the clients 200, 300, and then can present the specified content data in lists to the user who has returned home, so that the user can selectively play the specified content data smoothly by a remote controller. It should be further noted that the function provided by the content list module 126 in which the user can selectively play the content data which has been stored locally does not conflict with the function provided by the message list module 125 in which the user selects to play locally the content data which has been downloaded. Specifically, the content list module 126 presents all the content data stored in the content terminal 12 in lists, while the message list module 125 only presents the command messages acquired by the message acquiring module 121. In other words, as for the content data to be downloaded as indicated by the command messages acquired by the message acquiring module 121, when the content data has been downloaded, the user can select to play this content data not only by using the message list provided by the message list module 125, but also by using the content list provided by the content list module 126. While as for the content data inputted to the content terminal 12 from other sources, the user can select to play the content data by using the content list provided by the content list module 126.

In a preferred embodiment, the content terminal 12 further comprises a video outputting interface 127, which is used to output the signals for playing video (including video signals and audio signals) to display on a display device like a HDTV, a computer screen, etc. The video outputting interface 127 may comprise currently popular video interfaces, e.g. TV-OUT, HDMI, etc.

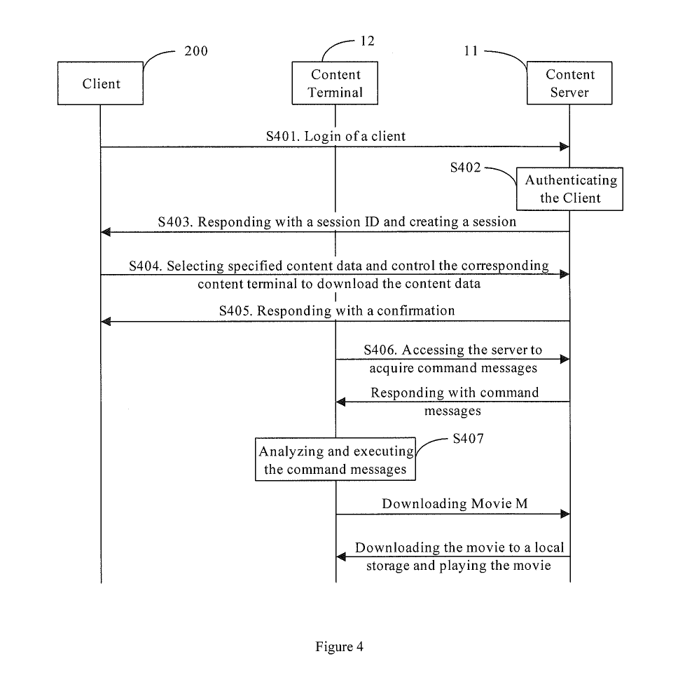

Based on the above embodiment of the content server system including the content server 11 and the content terminal 12, the present invention further provides a content service method, an embodiment of which is shown in FIG. 4, comprising the steps of:
S401, login of a client,

wherein with a terminal like a smart/non-smart phone, a computer, etc., the client (e.g. the client 200) logins a content service page provided by the content server 11 by inputting a username and a password;
S402, authenticating the client,

wherein the content server 11 authenticates the client 200 according to the username and the password inputted by the user;
S403, responding to the client with a session ID and creating a session,

wherein after authenticating the client 200, the content server 11 responding to the client 200 with a session ID, so as to create a session between the content server 11 and the client 200;
S404, selecting specified content data and controlling the corresponding content terminal to download the content data,

wherein with a terminal management interface provided by the content server 11, the authenticated client 200 can check the online status of the content terminal corresponding to the client 200; and upon finding the specified content data (e.g. a movie M) on the content service page provided by the content server 11, the client 200 can select an online content terminal 12 to download the specified content data for example by clicking “DOWNLOAD” to generate command messages in a specific format which is to be sent to the content server 11; and the command messages is then used to specify the content data to be downloaded by the content terminal 12;

S405, responding to the client with a confirmation to indicate that the command messages have been received,

wherein upon receiving the command messages sent by the client 200, the content server 11 stores these command messages in queue according to the terminal ID of the content terminal 12 contained in the message, and simultaneously responding to the client 200 with a confirmation indicating that the command messages have been received;

S406, accessing the server with the content terminal to acquire command messages,

wherein the content terminal 12 accesses the message queue maintained by the content server 11 at regular intervals, and accesses the message queue using its own terminal ID to acquire the command messages which have been normalized in format by the content server 11;

S407, analyzing and executing the command messages,

wherein the content terminal 12 identifies the movie M selected by the client 200 by analyzing the acquired command messages, so as to continue accessing the content server 11 and download the movie M to a local storage; and when the user of the client 200 returns home, he/she can watch the downloaded movie M by selecting on the playlist of the content terminal 12.

In summary, according to the content service system, the method, the content server, and the content terminal in the embodiments of the present invention, it is possible for the client to select the content data in the content server and control the content terminal in the home to download and store locally the content data, so that when the user returns home, the content data which has been stored locally can be played directly with the content terminal. As a result, the phenomena, in which the streaming media cannot be played smoothly due to the network problems, can be avoided, and it is more convenient for the user to operate.

Although the present invention has been described with reference to some typical embodiments, it should be understood that the terms are illustrative and exemplary, but not restrictive. Since the present invention can be implemented in various forms without departing from the spirit or essence of the present invention, it should be understood that these embodiments are not restricted to the details described above but should be construed broadly within the spirit and scope defined by the appended claims, and all variations and modifications falling within the claims or their equivalents are intended to be covered by the appended claims.

1. A content service system, which comprises a content server and a content terminal that are connected via the internet,
wherein the content server is further connected with a client via the internet and comprises:
a content database, for storing content data to be downloaded by the content terminal via the internet; and
a message queue module, for receiving command messages from the client via the internet, the command messages being used to specify the content data to be downloaded by the content terminal; and
wherein the content terminal comprises:
a message acquiring module, for accessing the content server via the internet to acquire the command messages; and
a content downloading module, for downloading the specified content data from the content server via the internet according to the command messages, and storing the specified content data locally for playing.

2. A content server, which is connected with a client and a content terminal respectively via the internet, comprising:
a content database, for storing content data to be downloaded by the content terminal via the internet; and
a message queue module, for receiving command messages from the client via the internet and storing the command messages according to the terminal ID of the content terminal, the command messages being used to specify the content data to be downloaded by the content terminal.

3. The content server according to claim 2, further comprising:
a terminal management interface, through which the client can add a content terminal, check the online status of a content terminal, and send the command messages.

4. The content server according to claim 3, further comprising:
an authentication login interface, through which the client can be authenticated, so that the client which has been authenticated can operate the content terminal through the terminal management interface.

5. The content server according to claim 4, wherein the authentication login interface comprises:
a password authentication module, for performing authentication on the client by verifying the inputted username and password; and/or
a terminal ID authentication module, for performing authentication on the client by verifying the contained terminal ID of the content terminal.

6. The content server according to claim 5, further comprising:
a page presentation module, for presenting the content data stored in the content database in form of pages to the client, and for providing a first interface for the client to input a username and a password and a second interface for indicating whether the content terminal is online.

7. A content terminal, which is connected with a content server via the internet, comprising:
a message acquiring module, for accessing the content server via the internet according to a terminal ID of the content terminal to acquire command messages of a client, the command messages being used to specify the content data to be downloaded by the content terminal; and
a content downloading module, for downloading the content data from the content server via the internet according to the command messages, and storing the content data locally for playing.

8. The content terminal according to claim 7, further comprising:
a timing module, for controlling the message acquiring module to access the content server via the internet at regular intervals to acquire command messages.

9. The content terminal according to claim 8, further comprising:
a message list module, for presenting the acquired command messages in lists to the user, so that the user can check the downloading progress, select to play online the content data which has not been downloaded, and select to play locally the content data which has been downloaded;
a content list module, for presenting the content data which has been stored locally in lists to the user so that the user can selectively play the content data.

10. A content service method, which is applied to a content service system including a content server and a content terminal that are connected via the internet, the content server is further connected with a client via the internet, the method comprising the steps of:
storing content data to be downloaded by the content terminal via the internet in the content server, and after receiving command messages from a client via the internet, storing the command messages according to a terminal ID of the content terminal, the command messages being used to specify the content data to be downloaded by the content terminal; and
accessing the content server via the internet by the content terminal according to a terminal ID of the content terminal, downloading the specified content data from the content server via the internet according to the command messages, and storing the specified content data locally for playing.
